(19) United States
(12) Patent Application Publication
(10) Pub. No.: US 2011/0145899 A1
(43) Pub. Date: Jun. 16, 2011

(54) Single Action Authentication via Mobile Devices

(75) Inventors: Rong Cao, Milpitas, CA (US); Len Osamu Toyoshiba, San Jose, CA (US); Liyu Yi, Fremont, CA (US); Rosarin Antonyraj, Sunnyvale, CA (US); Erica Huang, Sunnyvale, CA (US)

(73) Assignee: VeriSign, Inc., Mountain View, CA (US)

(21) Appl. No.: 12/635,252

(22) Filed: Dec. 10, 2009

(51) Int. Cl. H04L 9/32

(52) U.S. Cl. 726/7

(57) ABSTRACT

A method for authenticating a user includes receiving a user identification, confirming the user identification, sending a request to the user to perform a single action on a communication device, creating a session to receive the single action from the communication device, receiving an identifier from the communication device, using the identifier to verify that the user has the communication device, and authenticating the user based on the confirmed user information and the verification that the user has the communication device. The identification can include a username and a password or can be a one time password.

### BACKGROUND OF THE INVENTION

The invention relates to a system and method for authenticating a user using a communication device, such as a mobile device, prior to the user conducting a transaction with an entity, e.g., a bank. A third party, such as VeriSign®, provides the authentication service in a manner transparent to the user.

Each year, many people and organizations become victims of identity theft. Identity theft has become such a big problem that losses stemming from identity theft are estimated to be billions of dollars, on an annual basis. As more consumers use computers and mobile devices for shopping, managing their finances, and accessing health care information, the risk of fraud and identity theft increases. More and more enterprises have started deploying strong authentication solutions for their online consumer base. In general, these solutions require users to present at least two factors (e.g. a static password and a smartcard or One Time Password (OTP) token) as proof of identification when conducting business.

Most of the strong authentication solutions available today are not simple to use and require that a user learn procedures, which are not intuitive, in order to be able to effectively use the existing authentication solutions. For example, a smart card certificate based solution requires the understanding of certificates, personal identification numbers (PINs), and smart card driver compatibilities. A One Time Password (OTP) based solution requires reading and entering a 6 digit dynamic pass code into a login screen. A battleship card based solution requires the looking up of information in sophisticated matrix tables. All of these solutions are difficult to learn and understand, and are therefore cumbersome to use.

Therefore, what is needed is a system and method that provides strong authentication protection, which operates behind the scenes without sacrificing conveniences of everyday web lifestyles, while delivering a simple user experience.

### BRIEF SUMMARY OF THE INVENTION

Embodiments of the invention provide strong authentication protection, which operates behind the scenes without sacrificing the conveniences of everyday web lifestyles. One convenience that is provided is enabling a simple “single action” authentication experience. Embodiments of the invention include systems and methods for authenticating a user using a communication device, such as a mobile device, prior to the user conducting a transaction with an entity, e.g., a bank. A third party authentication service, such as VeriSign®, authenticates the user in a manner transparent to the user.

According to embodiments, a user can register his communication device with an entity prior to accessing entity's network. The entity can then assign a unique identifier (ID) to the communication device and store the registration information in a database. For example, the unique ID could be the token ID, the phone number of the communication device (MSISDN) or the MAC address of the communication device. In addition, the user may have to install an application on his communication device in order to communicate with an authentication service. The application can be provided by VeriSign® and can contain a security credential associated with the ID of the communication device, e.g., a One Time Password, a public key infrastructure (PKI) certificate, or combinations of a variety of different factors. An example of an authentication service is VeriSign One-Click Authentication Service (VOCAS).

In embodiments a system and method for authenticating a user of a communication device, such as a mobile device, using a third party authenticator, such as VeriSign® includes a one-step process of pushing a designated key on the communication device. In some embodiments, the communication device requests access to a pre-existing authenticated session between an entity and an authentication service, such as VOCAS. In other embodiments, the authentication service communicates with the user to initiate an authenticated communication channel and subsequently creates a channel upon confirmation by the user.

### BRIEF DESCRIPTION OF THE DRAWINGS

A further understanding of the nature and advantages of the invention may be realized by reference to the remaining portions of the specification and the drawings, presented below. The Figures are incorporated into the detailed description portion of the invention.

FIG. 1 is a simplified schematic diagram showing how an enhanced authentication protection is generated using a direct one way communication between a single action communication device and an authentication service, according to another embodiment.

FIG. 2 is a simplified schematic diagram showing how an enhanced authentication protection, using an image or challenge, is generated using a direct one way communication between a single action communication device and an authentication service, according to another embodiment.

FIG. 3A is a simplified schematic diagram showing how authentication protection is generated using a two-way communication between a single action communication device and an authentication service, according to another embodiment.

FIG. 3B is a simplified schematic diagram showing how authentication protection, using an image or challenge, is generated using a two-way communication between a single action communication device and an authentication service, according to another embodiment of the present invention.

FIG. 4 is an illustration showing a communication device used in accordance with an embodiment.

FIG. 5 is flowchart illustrating the registration and authorization of a user holding a single action device with a Relying Party, according to an embodiment.

FIG. 6 is flowchart illustrating operations performed by a Relying Party to authenticate a user, according to an embodiment.

FIG. 7 is flowchart illustrating operations performed by an authentication service to authenticate a user, according to an embodiment.

FIG. 8 is flowchart illustrating operations performed by a combination of a Relying Party and an authentication service to authenticate a user, according to an embodiment.

FIG. 9 is flowchart illustrating operations performed by a combination of a Relying Party and an authentication service using an image to authenticate a user, according to an embodiment.

FIG. 10 is flowchart illustrating operations performed by a combination of a Relying Party and an authentication service in a two-way communication, according to an embodiment.

### DETAILED DESCRIPTION OF THE INVENTION

Embodiments of the invention provide strong authentication protection operating behind the scenes without sacrificing the convenience of everyday web lifestyles. One convenience that can be provided is enabling a simple “single action” authentication experience. Embodiments of the invention include systems and methods for authenticating a user through a communication device, such as mobile device, prior to or as part of the user conducting a transaction with an entity, e.g., a bank or other relying party, using an authenticated communication link. A third party authentication service, such as VeriSign®, can authenticate the user in a manner that is fairly transparent to the user. Prior to accessing the entity's network, the user can register his communication device with the entity. The entity can then assign a unique identifier (ID) to the communication device and store the registration information in a database. For example, the unique ID could be a token ID, the phone number of the communication device (MSISDN) or the MAC address of the user communication device. In addition, the user may install an application on his communication device in order to communicate with the authentication service, such as VOCAS. The application can be provided by VeriSign® and can contain a security credential associated with the ID of the communication device, e.g., a One Time Password, a public key infrastructure (PKI) certificate, or the like.

In embodiments a system and method for using a third party authenticator, such as VeriSign®, to authenticate a user using a communication device, such as a mobile device includes a single action process of pushing a designated key on the communication device. In some embodiments the communication device requests access to a pre-existing authenticated session between an entity and an authentication service, such as VOCAS. In other embodiments, the authentication service communicates with the user to initiate an authenticated communication channel and subsequently creates a channel upon confirmation by the user. This authenticated communication channel can be separate from the communication channel over which the user communicates with the entity. For example, the user may communicate with the entity using HTTP over the Internet, while the separate authenticated communication channel may be between VOCAS and a user cell phone over a cell phone network.

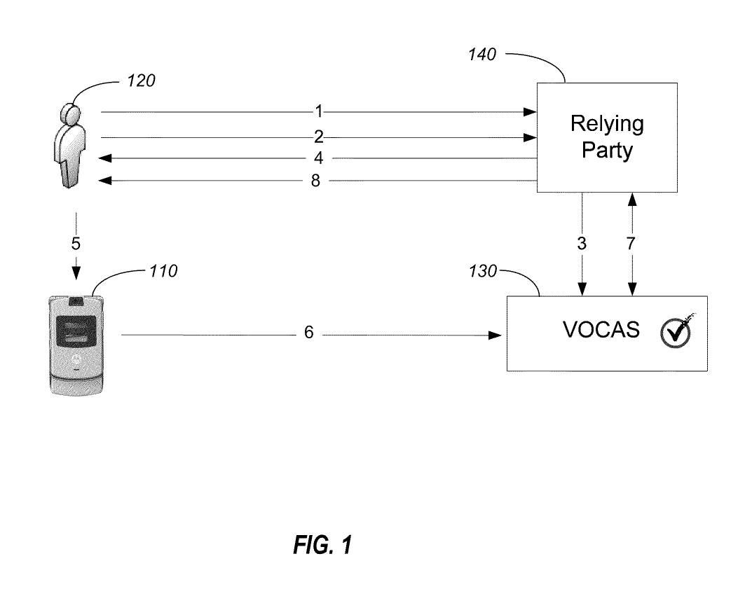

FIG. 1 is a simplified schematic diagram showing how an enhanced authentication protection is generated using a direct one way communication between a single action device 110, which is handled by a user 120, and an authentication service 130 via a relying party 140, according to another embodiment of the invention. According to an embodiment, a user 120 holding a single action communication device 110 communicates with an authentication service 130 via a relying party 140 or via single action communication device 110. The single action device 110 is a communication device that the user 120 can use to communicate with others. The single action device 110 can be a mobile device such as a mobile phone, a personal digital assistant (PDA), a smart-phone, net-book, laptop, or any computerized communication device. The authentication service 130 is a hosted authentication service provided by a company such as VeriSign®. In one embodiment the authentication server 130 can be a website or software running on the server. The relying party 140 is an online service provider that delivers online services through the Internet. The relying party 140 can be an online service provider such as Google®, Yahoo® or other company website that is used to provide services such as financial services, ecommerce, healthcare, social networking and etc.

In FIG. 1, the user 120 registers himself/herself and the communication device 110 with the relying party 140 through the communication link identified as 1. After the user 120 is registered with the relying party 140, the user 120 access an online web application running on the relying party 140, through the communication link identified as 2. When the user 120 accesses the relying party 140, which can be a web-site, the user provides at least one credential such as a username/password, a One Time Password, a digital signature and/or biometric data to access the website. In some embodiments, the user only provides the username and not the password via a login page. In other embodiments, the user provides another credential or other combination of credentials via a login page. The communication device 110, which is shown as a mobile device, can be a “single action” (e.g., click a button) device. The relying party 140 then retrieves an identifier of a user mobile device, which was previously registered with the relying party 140, and forwards this information via communication link 3 to the authentication service 130, which can be VOCAS, to initiate the single action authentication process. The authentication service 130 creates a session for this transaction that will be used to communicate back to the relying party, as shown in communication link 7. The relying party 140 also displays a message to the user 120 on the web page, as shown by communication link 4, requesting the user 120 to respond with the communication device 110. The relying party 140 can display the request to the user 120 before, after or simultaneously to forwarding the information to the authentication service. That is, communication link 3 can occur before communication link 4, after communication link 4, or at the same time as communication link 4.

The user 120 then performs the “single” action on the communication device 110, as shown by link 5, and the communication device 110 sends a signal to the authentication service 130 via communication link 6. The signal sent by the communication device 110 to the authentication service 130 via communication link 6 can be a text message, a one time password, a one time password generated based on a specific transaction, include biometric data, a signed message by the device certificate, which is installed on communication device 110, etc.

For example, a specific transaction can include transfer of money or approval of the action to transfer money. The signed message itself can also be a specific transaction by typing in transaction details or scanning transactions to generate a signed message using certificate and sending the signed message to VOCAS. In one embodiment, the communication device 110 runs a security application, which has been previously installed. The security application is associated with one or multiple security credentials. The security credential can take on various forms such as, for example, an OTP credential or a PKI certificate credential. The security application can also be bound to a designated key of the communication device 110, so that the user 120 only has to select or click the designated key to send a signal to the authentication device 110 via communication link 6. Once the designated key is selected, the application sends security credential to authentication server 130 to prove that the user 120 has the communication device 110. The security credential can be a digital signature, an OTP or other security credential.

After the authentication server 130 receives the information from the communication device 110, the authentication server 130 validates the security credential and associates the validation result (e.g., whether the user was successfully authenticated by the authentication server 130) with the session created earlier during communication link 3 In one embodiment the session can be identified by matching up the identifier of the mobile device or any other identifier associated with the user at the relying party 140. The validation result is then communicated back to the relying party 140 though communication link 7. In one embodiment, the authentication server 130 pushes the validation result back to the relying party 140 and in another embodiment, the relying party 140 pulls the validation result from authentication server 130. If the authentication service 130 cannot authenticate the user 120 or the communication device 110 then the authentication service 130 sends the result to the relying party 140, which can then decide whether or not to reject the user 120. The authentication service 130 will not authenticate the user 120 or communication device 110 if the identifier or the user identification does not match what is expected. Finally, the relying party 140 either grants or denies access, based on the validation result, and can communicate that decision back to the user 120 using communication link 8.

The relying party 140 can perform several operations to authenticate a user 120. Some of the operations performed by the relying party 140 can include receiving a user identification from a web application, forwarding the user identification to the authentication service 130 for user authentication, while at the same time sending a request to the user 120 to perform a single action on the communication device 110. Once the user is authenticated by the authentication service 130, the relying party grants or denies user access based on validation result from the authentication service 130.

The authentication service 130 can perform several operations to authenticate a user 120. Some of the operations that can be performed by the authentication service 130 include receiving a user 120 identification from relying party 140, receiving an identifier from the communication device 110, authenticating the user 120 by verifying the user identification received from relying party 140 and the identifier received from the communication device 110. Biometrics may also be used, such as receiving biometric data from the user (e.g., iris scan, fingerprint data, etc.) and verifying it. The validation result is then communicated back to the relying party 140. If the authentication service 130 cannot authenticate the user 120 or the communication device 110 then the authentication service 130 sends a message to this effect to the relying party 140, which can decide whether or not to reject the user 120. The authentication service 130 will not authenticate the user 120 or the communication device 110 if the user-supplied credential cannot be verified.

The combination of the relying party 140 and the authentication service 130 performs several operations to authenticate a user 120. Some of the operations performed by the combination of the of the relying party 140 and the authentication service 130 can include receiving a user 120 identification, confirming the user identification, sending a request to the user 120 to perform a single action on a communication device 110, creating a session to receive the single action from the communication device 110, receiving an identifier from the communication device 110, using the identifier to verify that the user 120 has the communication device 110, and authenticating the user 120 based on the confirmed user information and the verification that the user has the communication device 110.

The user identification can be any information that can be used to identify the user. The identifier can be information that is used to identify the communication device 110. In one embodiment the user identification can include a username. In some cases, the identifier can include an authentication credential. For example, an identifier can include a username and a password. In other embodiments that user identification can include information such as social security number, addresses, date of birth, country or origin or any other information that can be used to identify a user 120. The identifier can also be a one time password or a password that never expires and can only be changed by the user 120. Alternatively, a combination of the password and one time password can be used. In another embodiment where the communication device 110 is a handheld communication device such as a mobile telephone or other handheld device, the identifier can include a token ID in any form or phone number, Mobile Identification Number, Electronic Serial Number, etc., of the handheld communication device. The token ID identifies hardware or software credential such as a mobile token, a key fob etc. The identifier can also be a certificate, such as a device certificate. In other embodiments, the authentication of the communication device 110 can be done by associating the communication device 110 with a session initiated by the authentication service 130 when user identifier is received.

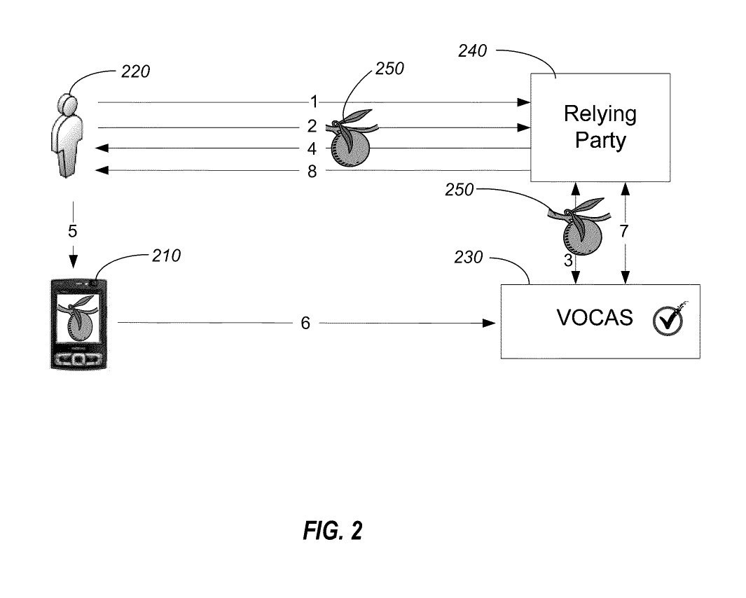

FIG. 2 is a simplified schematic diagram showing how an enhanced authentication protection using an image 250 that is generated using a direct one way communication between a single action device 210, which is handled by a user 220, and an authentication service 230 via a relying party 240, according to another embodiment of the invention. As used herein, the term “image” includes any content that can be perceived by a user, such as textual, photographic, a graphical, audio, video, animation or any other kind of information. The authentication procedure illustrated in FIG. 2 is similar to the authentication procedure illustrated in FIG. 1, except that the transaction linkage is stronger. The sessions created between the relying party 240 and the user 220 can be associated with specific transactions. The image 250, illustrated in FIG. 2, can be used strengthen the linkage between the communication device 210 and the specific transaction.

In FIG. 2, the user 220 registers himself/herself and the communication device 210 with the relying party 240 through the communication link identified as 1. After the user 220 is registered with the relying party 240, the user 220 access an online web application running on the relying party 240, through the communication link identified as 2, by supplying a username and password to a login page running on the relying party 240. In some embodiments, the password is not provided and only the username is provided. The communication device 210, which is shown as a mobile device, is the “single action” device. The relying party 240 then retrieves the identification, which was previously registered, and forwards, via communication link 3, this information to the authentication service 230, which can be VOCAS, to initiate the single action authentication process.

The authentication service 230 creates a session for this transaction that will be used to communicate back to the relying party, as shown in communication link 7. For each session or transaction created for the communication device 210, the authentication service 230 can also generate an image 250 associated with that session or transaction. In one embodiment, the image 250 can be selected by the authentication service from a group of available images. The group of available images can be any size and can consist of any kind of images or be any form of challenge. As used herein, the term “image” includes any content that can be perceived by a user, such as textual, photographic, a graphical, audio, video, animation or any other kind of information. The number of images in the group of available images can be N where N is an integer greater than or equal to 1. The kind of images in the group of available images can be images of almost anything such as images of fruits, cars, buildings, people, etc. In one embodiment, the group of images contains five fruit images, which include an image of an apple, an image of an orange, an image of a peach, an image of a cherry, and an image of a banana. For example, when a session is created, the authentication service 230 can randomly associate one of the fruit images, for example, peach, with the session. The authentication service 230 can then notify, via communication link 3, the relying party 240 which image 250 was selected and the relying party 240 can display this selected image 250 to the user 220 while requesting the user 220 to perform a one click authentication, via communication link 4. In one embodiment, this can be done by associating each selected image 250 with an image index number so that the authentication service 230 sends the index number to the relying party 240.

The user 220 then can perform the enhanced “single action” on the communication device 210 through communication link 5. After the user performs the single click action, the communication device 210 runs a security application, which has been installed and contains one or multiple security credentials. The security credential can take on various forms such as, for example, an OTP credential or a PKI certificate credential. The security application can cause the communication device 210 to display a group of images, one of which corresponds to the image 250 displayed by the relying party 240 to the user 220. The user 220 is asked to select the image from the group of images shown on the mobile device 210 that matches the image 250 displayed on the relying party 240 web site. Since the user 220 accessing the relying party 240 web site is suppose to have access to the mobile device 210 by asking the user to select the correct image on the communication device 210, an extra layer of assurance is provided that the user 220 accessing the relying party 240 is the authorized user. Since the user 220 is suppose to be the holder of the communication device 210, by independently verifying that the holder of the communication device 210 is viewing the information displayed by the relying party 240, the user 220 is authenticated. The security application can also be activated by a designated key on the keypad of the communication device 210, so that the user 220 only has to select or click the designated key associated with the selected image to send a signal corresponding to the selected image 250 to the authentication server 230 via communication link 6. Once the designated key is selected, the application sends the security credential along with the signal to authentication server 230 to prove the user 220 has this communication device 210, and to prove the user 220 grants or denies this transaction. In one embodiment, the security credential could be a digital signature, in the case of certificate, or a 6 digit password in the case of OTP.

After the authentication server 230 receives the information from the communication device 210 in communication link 6, the authentication server 230 validates the security credential and associates the validation result with the session, which was created earlier during communication link 3. The authentication server 230 can also determine if the image selected by the holder of the mobile device 210 is the same image as that displayed to the user interacting with the relying party 240. The validation result is then communicated back to the relying party 240 though communication link 7. If the authentication service 230 cannot validate the security credentials of the communication device 210 then the authentication service 230 still sends, via communication link 7, the authentication results to the relying party 240. The relying party 240 can then decide whether or not to reject the user. The authentication service 230 will not validate the communication device 210 if the identifier does not match what is expected by the session. In one embodiment, the authentication server 230 pushes the validation result back to the relying party 240 and in another embodiment, the relying party 240 pulls the validation result from authentication server 230. Finally, the relying party 240 either grants or denies access, based on the validation result, and communicates that decision back to the user 220 using communication link 8.

In addition to creating a stronger linkage between the communication device and the transaction at the relying party, the image 250 also enables the support of multiple transactions. In this case, the authentication service 230 creates separate image 250 for different transactions coming from the same user 220 at the same time.

When using the image 250 in the authentication process, several operations are performed to authenticate the user 220. First, a user identification is received by the relying party 240. The user identification is then confirmed. Next, a session to receive the single action from the communication device 210 is created and the first image 250 is associated with the session. A request is then sent to the user 220 to perform a single action on the communication device 210. The first image is then sent to the user 220 along with a request that the user 220 select the same first image on the communication device. Next an identifier, which includes an indicator of the image selected by the user, is sent by the communication device 210 and is received by the authentication service 230. The identifier is then used to verify that the user 220 has the communication device 210. Finally, the user is authenticated based on the confirmed user information and the verification that the user 220 has the communication device 210. In one embodiment, authenticating the user 220 can include determining a match between the first image and the selected image. The identifier can be verified by matching a one time password from the device with the service. The communication device 210 can be a handheld communication device and the identifier can include the token ID, certificate or phone number of the handheld communication device. If the authentication service 230 cannot authenticate the user 220 or the communication device 210 then the authentication service 230 sends the result to the relying party 240. The authentication service 230 will not authenticate a user 220 or communication device 210 if the identifier or the user identification does not match what is expected by the session.

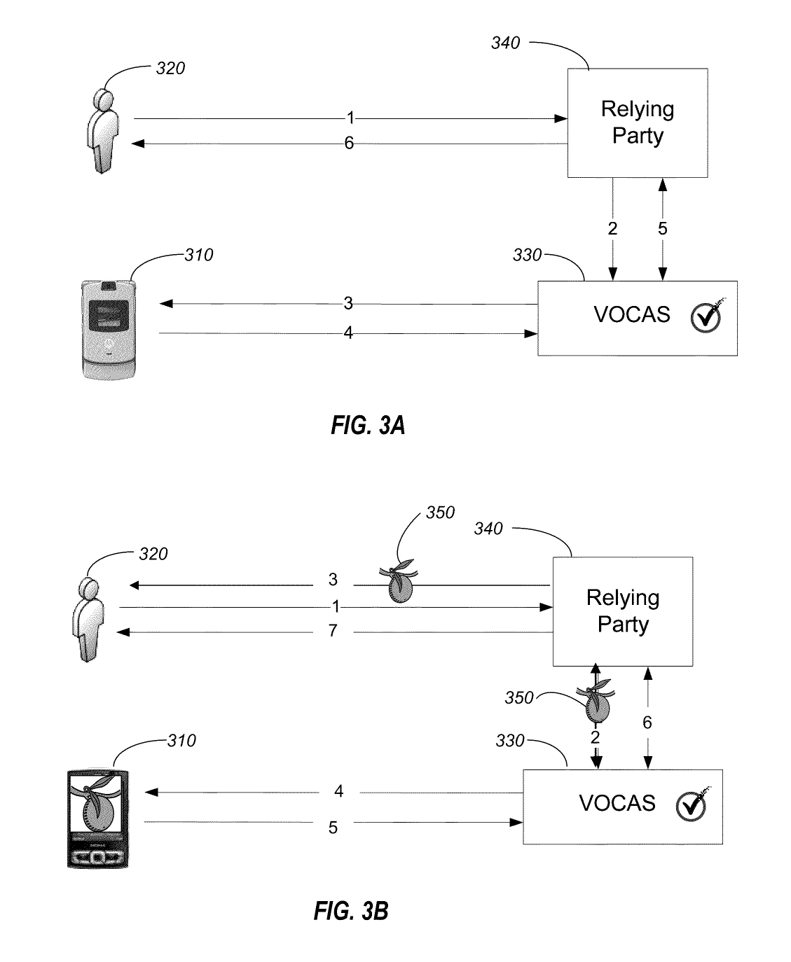

FIG. 3A is a simplified schematic diagram showing how authentication protection is generated using a two-way communication between a single action communication device 310, which is handled by a user 320, and an authentication service 330 via a relying party 340, according to another embodiment of the present invention. The single action communication device 310 is a communication device that the user 320 can use to communicate with others. The single action communication device 310 can be a mobile device such as a mobile phone, a personal digital assistant (PDA), a smart-phone, net-book, laptop, or any computerized communication device. The authentication service 330 is a hosted authentication service provided by a company such as VeriSign®. In one embodiment the authentication server 330 can be a website or software running on the server. The relying party 340 is an online service provider that delivers online services through the Internet. The relying party 340 can be an online service provider such as Google®, Yahoo®, or other company website that is used to provide services such as financial services, ecommerce, healthcare, social networking and etc.

In FIG. 3A, the user 320 has already registered the communication device 310 with the relying party 340. The user 320 accesses an online web application running on the relying party 340, through the communication link identified as 1, by supplying a username and password to a login page running on the relying party 340. In some embodiments, the password is not provided and only the username is provided. The relying party 340 then retrieves the identification and username, which were previously registered, and forwards, via communication link 2, the retrieved information to the authentication service 330, which can be VOCAS, to initiate the single action authentication process. The authentication service 330 then reaches out to the user 320 via the communication device 310 through communication link 3 and requests that the user 320 respond with the single action. In one embodiment, the request can include a transaction description.

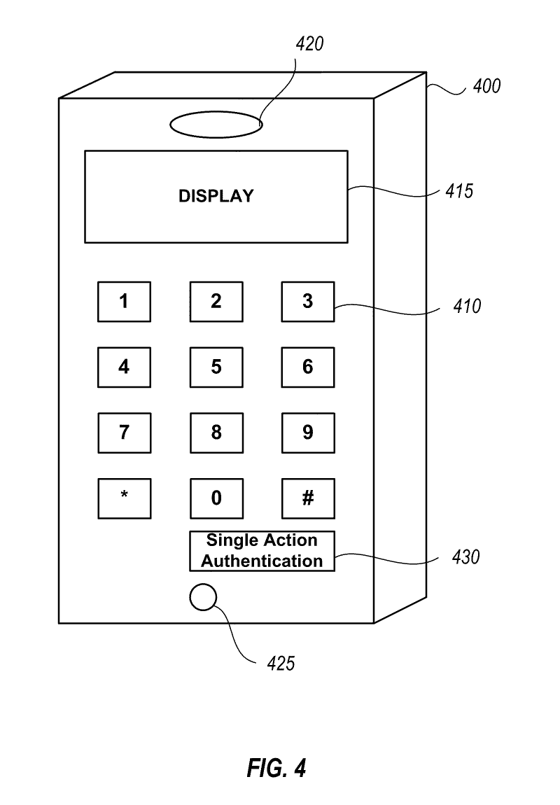

The user 320 then performs the “single action” on the communication device 310 and sends a signal to the authentication service 330 via communication link 4. After the authentication server 330 receives the information from the communication device 310, the authentication server 330 validates the user and the validation results are then communicated back to the relying party 340 through communication link 5. Finally, the relying party 340 either grants or denies access, based on the validation result, and communicates that decision back to the user 320 using communication link 6 If the authentication service 330 cannot authenticate the communication device 310 then the relying party 340 rejects access to the user 320. The authentication service 330 will not authenticate the user 320 or communication device 310 if the identifier or the user identification does not match what is expected by the session. The communication device 310 is similar or the same to the other communication devices discussed above with reference to FIGS. 1-2 and below with reference to FIG. 4 and can contain the same features as these communication devices.

FIG. 3B is a simplified schematic diagram showing how authentication protection using an image or challenge 350 is generated using a two-way communication between a single action communication device 310, which is handled by a user 320, and an authentication service 330 via a relying party 340, according to another embodiment of the present invention. This schematic is similar to the schematic of FIG. 3A except that for each session created for a communication device 310 the authentication service 330 also generates an image 350. The image 350 can be used to enable the support of multiple transactions. In this case, the authentication service 330 creates a separate image 350 for different transactions coming from the same user 320 at the same time. The image 350 can also be used to enhance the security features of the system. In one embodiment, the image 350 can be selected from a group of images. The group of images can be any size and can consist of any kind of images or be any form of challenge. For example, the number of image in the group of images can be N where N is an integer greater than or equal to 1 and the kind of images can be images of anything such as fruits, cars, buildings, people, etc. In one embodiment, the group of images contains five fruit images, which include an image of an apple, an image of an orange, an image of a peach, an image of a cherry, and an image of a banana.

The user 320 accesses an online web application running on the relying party 340, through the communication link 1, by supplying a username and password to a login page running on the relying party 340. In some embodiments, the password is not provided and only the username is provided. The relying party 340 then retrieves the identification and username, which were previously registered, and forwards the retrieved previously registered information to the authentication service 330, via communication link 2, to initiate the single action authentication process. The authentication service 330 can be VOCAS. The authentication service 330 creates a session and randomly associates an image 350 with the session and sends the image to the relying party 340 via communication link 2. The relying party 340 then displays the image 350 to the user 320 via communication link 3. The authentication service 330 also sends the same image 350 to the communication device 310 through communication link 4 and requests that the user 320 respond with the single action communication device 310 verifying that the image 350 associated with the session is being displayed by the relying party 340. In one embodiment, the authentication service 330 sends the image 350 at the same time to both the relying party 340 and the communication device 310, via communication links 2 and 4, respectively. In another embodiment, the authentication service 330 sends the image 350 to the relying party 340 and the communication device 310 at different times. In other embodiments, the authentication service 330 can wait until it receives confirmation that the relying party has displayed the image 350 before sending the image 350 to the communication device 310 via communication link 4.

If the user 320 sees the same image being displayed on the communication device 310 as on the relying party 340 display, then the user 320 performs the “single action” on the communication device 310 and sends a signal to the authentication service 330 via communication link 5. After the authentication server 330 receives the information from the communication device 310, the authentication server 330 validates the user. The validation results are then communicated back to the relying party 340 through communication link 6. Finally, the relying party 340 either grants or denies access, based on the validation result, and communicates that decision back to the user 320 using communication link 7 If the authentication service 330 cannot authenticate the communication device 310 then the relying party 340 rejects access to the user 320. The authentication service 330 will not authenticate the user 320 or communication device 310 if the identifier or the user identification does not match what is expected by the session. The communication device 310 is similar or the same to the other communication devices discussed above with reference to FIGS. 1-2 and below with reference to FIG. 4 and can contain the same features as these communication devices.

In some embodiments, the authentication service 330 associates the selected image 350 with an image index number and sends the index number to the relying party 340 and the communication device 310 via communication links 2 and 4, respectively.

Two-way communication can be more secure than one-way communication because the communication device 310 holder has additional information beyond what is already displayed on the relying party 340. For example, the message received by the communication device 310, via communication link 4, can contain a description of the transaction such as “user Joe transfer $500,000 from account A to account B.” This brings transaction validation advantages because a user who visits the relying party 340 web site might only try to authorize the transaction with a different amount such as $500 instead.

In other embodiments that authorization can be done remotely. When authorization is done remotely, the authentication service 330 sends a signal to the remote party that will authorize a transaction. In one embodiment, the authorization service 330 sends to the remote party via communication link 4 a request that the remote party authorize a particular transaction or user. The remote party can also use the single action communication device 310 to authorize the user and transaction in the same way the user would have authorized the transaction had the user been requested to authorize the transaction. Once the remote party receives the request, the remote party performs the “single action” or other authorization action on the communication device 310 and sends a signal to the authentication service 330 via communication link 5. After the authentication server 330 receives the information from the communication device 310, the authentication server 330 validates the user and the validation results are then communicated back to the relying party 340 through communication link 6. Finally, the relying party 340 either grants or denies access, based on the validation result, and communicates that decision back to the user 320 using communication link 7 One example where remote authorization is useful is for parents monitoring the behavior of their children. For example, if a parent wishes to control spending of a child, the parent may request that the parent authorize any expense over $50 on a credit card. In this example, the authentication service would send a communication to the parent to approve the transaction.

FIG. 4 is an illustration of communication device used in accordance with the invention. The communication device 400 includes a key pad 410, a display 415, a speaker 420, a microphone 425 and a single action authorization key 430. The key pad can be a numeric key pad 410 as shown, which is found on many telephones, or an alphanumeric key pad as is found on a PDA or other computer. The display 415 is an electronic display and can be an LCD screen that is black and white or color. The speaker 420 is a speaker for generating sounds and transmitting voices or other sounds received by the communication device 400. The microphone 425 is for detecting sounds and can be used to speak into and communicate with other parties. The single action authorization key 430 can be a designated key on the keypad or the display of the communication device 400, so that a user only has to select or click the designated key to send a signal to an authentication device or other designated device. Once the designated key is selected, the communication device 400 (or application running on the device 400) sends predetermined information to another designated device. The communication device may have installed an application used to communicate with the authentication service. The application can be provided by VeriSign® and can contain a security credential associated with the ID of the communication device, e.g., a One Time Password, a public key infrastructure (PKI) certificate, or the like. The communication device 400 can also be a touch screen device where the single action authorization key is an image on the touch screen. Alternatively, the communication device 400 can use a voice activated command to serve as a one click authorization key. For example, if the user simply says a number such as “one” then the device can transmit data for the number and that can function as the single action authorization. In other embodiments, the communication device can be a simple communication device without a microphone. In another embodiment the authorization can be triggered using other entries such as a single key, combination of keys or sequence of keys.

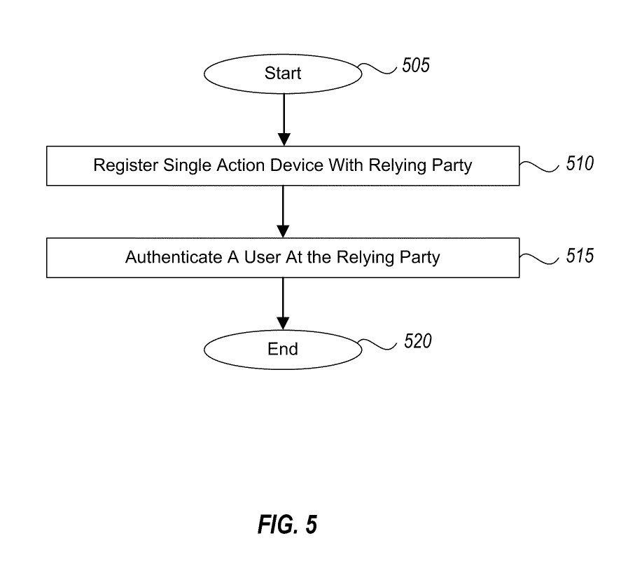

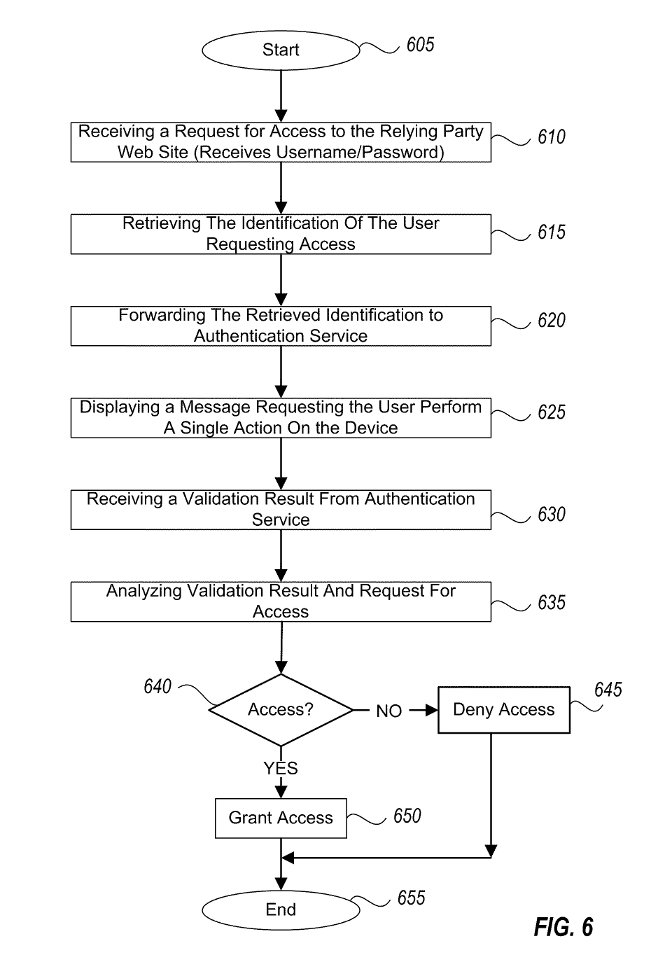

FIG. 5 is high level flowchart illustrating the registration and authorization of a user holding a single action device with a Relying Party, according to an embodiment of the present invention. The method starts in operation 505 when software running on a communication device, relying party and authentication service are initialized and started. In operation 510, the communication device which can be a single action authorization device, or the credential ID of the application running on the device or certificate serial number of the device certificate, is registered with a relying party as the user authentication identifier. The registration process can include setting up a username and/or password with the relying party so that the user can access applications running on the relying party by supplying the username and password. Next in operation 515, the user is authenticated by the relying party by using the password and/or username as well as other information which is retrieved by the authentication service. Additional details of operation 515 are provided below with reference to FIGS. 6-10. After the user is authenticated, the user is allowed to conduct whatever transaction he is trying to conduct and the process ends in operation 520. If the user or the communication device is not authenticated then the user is denied access.

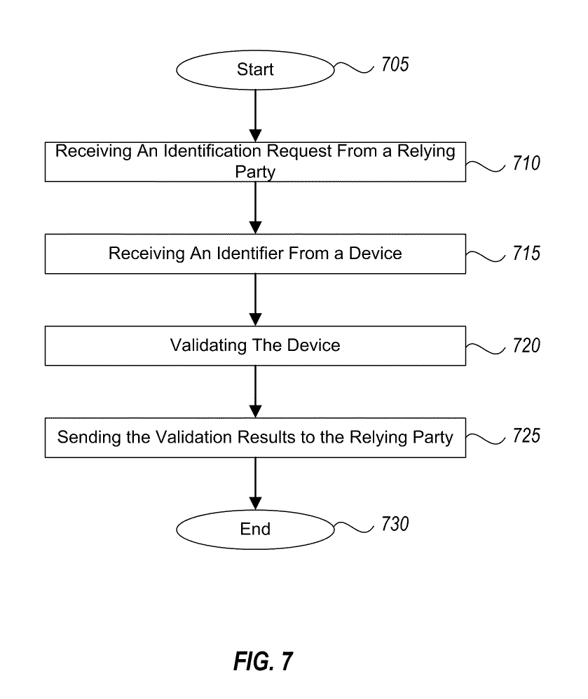

FIG. 6 is flowchart illustrating operations performed by a Relying Party to authenticate a user, according to an embodiment of the present invention. FIG. 6 illustrates additional details of operation 515 illustrated in FIG. 5. The method starts in operation 605 after the user and the communication device have been registered with the relying party. In operation 610, the relying party receives a request for access to the relying party website along with user identification. The user identification can include a username and/or password. Next in operation 615, the relying party retrieves the authentication identification of the user requesting access which was previously registered by the user in operation 510. In operation 620, the relying party forwards the retrieved identification to the authentication service, which can be VOCAS. Next in operation 625, the relying party displays a message requesting the user to perform a single action on the communication device. Next in operation 630, the relying party receives a validation result from the authentication service. A discussion of how the authentication service generates the validation results is provided below with reference to FIG. 7. After the relying party receives the validation results, the relying party analyzes the validation result as well as the request for access, in operation 635. In 640 a decision is made whether to grant access. This decision is based on information received from the user and the authentication service. If the decision in operation 640 is to deny access, then access is denied in operation 645 and the process ends in operation 655. Access is granted if the identifier and the user identification both match what is expected by the session. Access is denied if the identifier or the user identification does not match what is expected by the session. If the decision in operation 640 is to grant access, then access is granted in operation in 650 and the process ends in operation 655.

FIG. 7 is flowchart illustrating operations performed by an authentication service, such as VOCAS, to authenticate a user, according to an embodiment of the present invention. FIG. 7 illustrates additional details of operation 515 illustrated in FIG. 5. The method starts in operation 705 after the user and the communication device have been registered with the relying party. In operation 710, the authentication service receives an identification request from the relying party. In operation 715 the authentication service receives an identifier from a communication device. Next in operation 720, the user and the communication device are validated. The communication device is validated if the identifier of the communication device matches what is expected by the session. After the user and the communication device are validated, in operation 725 the authentication service sends the validation results to the relying party. After the validation results are sent to the relying party, the process ends in operation 730.

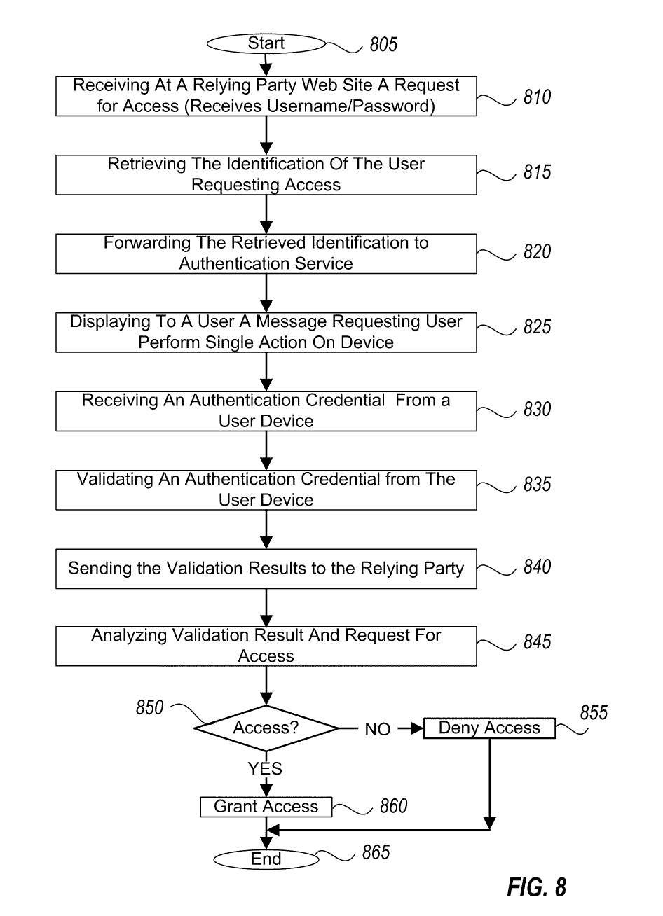

FIG. 8 is flowchart illustrating operations performed by a combination of a relying party and an authentication service, such as VOCAS, to authenticate a user, according to an embodiment of the present invention. Therefore, FIG. 8 is an embodiment showing a combination of FIGS. 6 and 7 and illustrates additional details of operation 515 illustrated in FIG. 5. The method starts in operation 805 after the user and the communication device have been registered with the relying party. In operation 810, the relying party receives a request for access to the relying party website along with user identification. The user identification can include a username and/or password. Next in operation 815, the relying party retrieves the identification of the user requesting access, which was previously registered by the user in operation 510. In operation 820, the relying party forwards the retrieved identification to the authentication service, which can be VOCAS. Next in operation 825, the relying party displays a message requesting the user to perform a single action on the communication device. When the user performs the single action on the communication device, the communication device sends an identifier to the authentication service. Next in operation 830, the authentication service receives an identifier from a communication device. In operation 835, the authentication service validates the communication device. After the communication device is validated, in operation 840 the authentication service sends the validation results to the relying party. After the relying party receives the validation results, the relying party analyzes the validation result as well as the request for access, in operation 845. In 850 a decision is made whether to grant access. This decision is based on information received from the user and the authentication service. If the decision in operation 850 is to deny access, then access is denied in operation in 855 and the process ends in operation 865. If the decision in operation 850 is to grant access, then access is granted in operation in 860 and the process ends in operation 865.

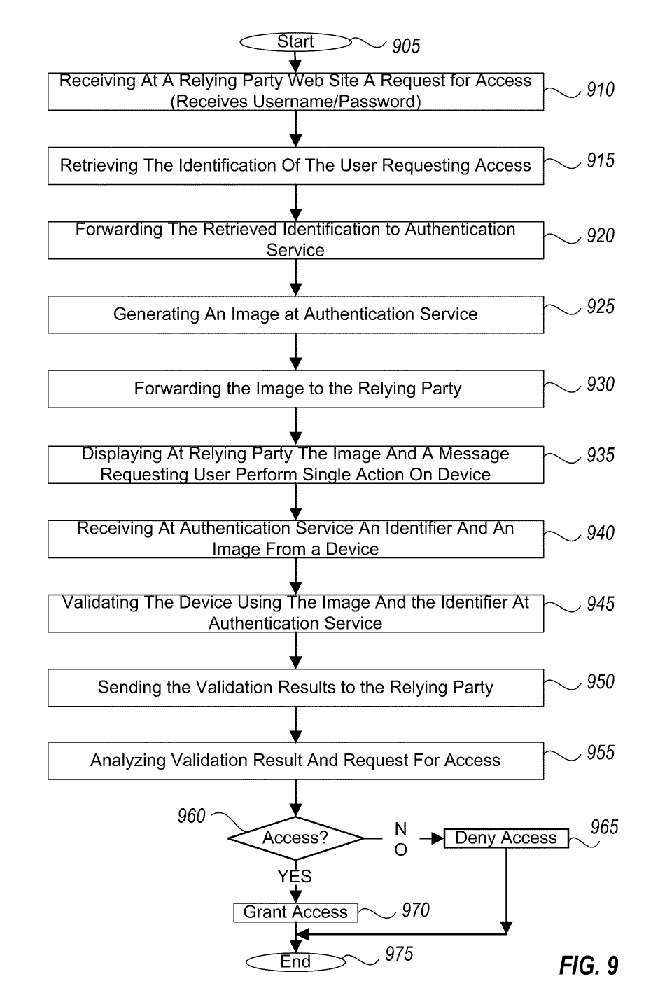

FIG. 9 is flowchart illustrating operations performed by a combination of a relying party and an authentication service, such as VOCAS, using an image to authenticate a user, according to an embodiment of the present invention. FIG. 9 illustrates additional details of operation 515 illustrated in FIG. 5 when an image is used to authenticate a user and a transaction. The method starts in operation 905 after the user and the communication device have been registered with the relying party. In operation 910, the relying party receives a request for access to the relying party website along with user identification. The user identification can include a username and/or password. Next in operation 915, the relying party retrieves the identification of the user requesting access, which was previously registered by the user in operation 510. In operation 920, the relying party forwards the retrieved identification to the authentication service, which can be VOCAS. Next in operation 925, a session and an image are generated at the authentication service. The session is related to a transaction and will be used to communicate back to the relying party. For each session created for a communication device, the authentication service also generates a picture image. In one embodiment, the image can be selected by the authentication service from a group of available images. The group of available images can be any size and can consist of any kind of images or be any form of challenge. The number of images in the group of available images can be N where N is an integer greater than or equal to 1. The kind of images in the group of available images can be images of almost anything such as images of fruits, cars, buildings, people, etc. In one embodiment, the group of images contains five fruit images, which include an image of an apple, an image of an orange, an image of a peach, an image of a cherry, and an image of a banana. For example, when a session is created, the authentication service can randomly associate one of the fruit images, for example, peach, with the session. After the image is generated, the authentication service forwards the image to the relying party in operation 930.

In operation 935, the relying party then displays to the user the image along with a message requesting the user to perform a single action on the communication device. When the user performs the single action on the communication device, the communication device sends to the authentication service an identifier along with an image selected by the user from a group of images to match the image displayed by the relying party. Next in operation 940, the authentication service receives an identifier and an image from a communication device. In operation 945, the authentication service validates the communication device using both the identifier and the image. The validation can be done both for the communication device and for a particular transaction. After the communication device is validated, in operation 950 the authentication service sends the validation results to the relying party. After the relying party receives the validation results, the relying party analyzes the validation result as well as the request for access, in operation 955. In 960 a decision is made whether to grant access. This decision is based on information received from the user and the authentication service. If the decision in operation 960 is to deny access, then access is denied in operation 965 and the process ends in operation 975. If the decision in operation 960 is to grant access, then access is granted in operation in 970 and the process ends in operation 975.

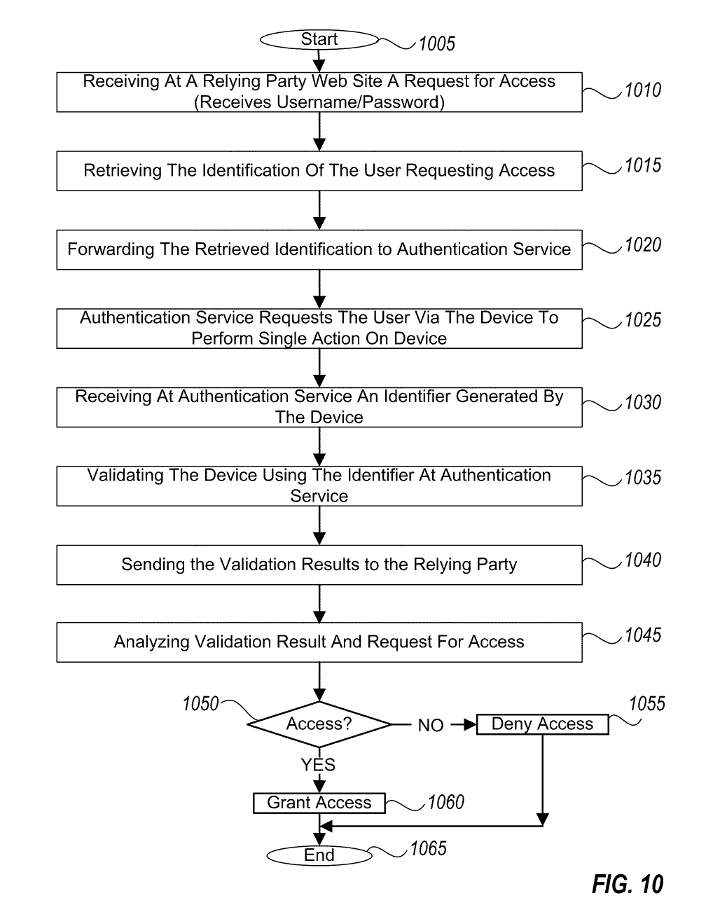

FIG. 10 is flowchart illustrating operations performed by a combination of a relying party and an authentication service, such as a VOCAS, in a two-way communication, according to an embodiment of the present invention. FIG. 10 illustrates additional details of operation 515 illustrated in FIG. 5. The method starts in operation 1005 after the user and the communication device have been registered with the relying party. In operation 1010, the relying party receives a request for access to the relying party website along with user identification. The user identification can include a username and/or password. Next in operation 1015, the relying party retrieves the identification of the user requesting access, which was previously registered by the user in operation 510. In operation 1020, the relying party forwards the retrieved identification, and optionally the transaction details, to the authentication service, which can be VOCAS. Next in operation 1025, the authentication service sends a message regarding the detailed transaction to the user and requests the user, via the communication device, to perform a single action on the communication device. When the user performs the single action on the communication device, the communication device generates and sends an identifier to the authentication service. Next in operation 1030, the authentication service receives an identifier from a communication device. The identifier can be one time password based on the transaction or signed message derived from the transaction by the certificate or by any other form which effectively identifies the device. In operation 1035, the authentication service validates the communication device using the identifier. After the communication device is validated, in operation 1040 the authentication service sends the validation results to the relying party. After the relying party receives the validation results, the relying party analyzes the validation result as well as the request for access, in operation 1045. In 1050 a decision is made whether to grant access. This decision is based on information received from the user and the authentication service. If the decision in operation 1050 is to deny access, then access is denied in operation in 1055 and the process ends in operation 1065. If the decision in operation 1050 is to grant access, then access is granted in operation in 1060 and the process ends in operation 1065.

In one embodiment, when the relying party forwards, in operation 1020, the retrieved identification, and optionally the transaction details, to the authentication service, a session and an image are also generated at the authentication service. The image can be used to enable the support of multiple transactions and to enhance the security features of the system. The session is related to a transaction and will be used to communicate back to the relying party. In one embodiment, the image can be selected from a group of images. The group of images can be any size and can consist of any kind of images or be any form of challenge. When a session is created, the authentication service also randomly associates one of the images with the session. After the image is generated, the authentication service forwards the image to the relying party. The authentication service then notifies the relying party which of the images was selected and the relying party displays this image back to the user while requesting the user to perform one click authentication. In the one click authentication the user verifies the same image being displayed on the communication device and sends a signal to the authentication service.

According to an embodiment, a computer-implemented method for authenticating a user includes receiving at a relying party from a user at least one first factor, verifying at the relying party the at least one first factor sent from the user to the relying party, sending a message from the relying party to the user requesting the user to contact a third party authentication service through a mobile device, sending from the user mobile device to the third party authentication service at least one second factor, verifying at the third party authentication service the at least one second factor sent to the authentication service, and sending a message from the third party authentication service to the relying party indicating whether the second factor sent to the third party authentication service has been successfully verified. If the message received from the third party authentication service indicates that the second factor sent to the third party authentication service has been successfully verified and if the relying party successfully verifies the first factor sent to the relying party, then determining that the user is authentic. The first factor includes at least one from the group of a user identifier, such as a user password, One Time Password, a digital signature and user biometric data. The second factor sent to the third party authentication service includes at least one from the group of a user identifier, such as a user password, a user One Time Password, a digital signature and user biometric data. The method can further include sending from the relying party to the user a first image, displaying the first image to the user, showing on the mobile device a group of images that includes the first image, and receiving from the mobile device at the third party authentication service a signal corresponding to an image selected by the user. If the image from the mobile device corresponds to the first image, then determining that the user is authentic.

According to another embodiment, a computer-implemented method for authenticating a user includes receiving at least one credential from a group of user credentials, validating the user credential, creating a session to receive a single action from a communication device, associating a first image with the session, sending a request to a user to select the same first image on the communication device, receiving an identifier from the communication device, using the identifier to verify that the user has the communication device, and authenticating the user based on the confirmed user information and the verification that the user has the communication device and has selected the image. The identifier can include a selected image selected by the user.

According to another embodiment, a computer-implemented method for authenticating a user includes receiving a user identification, sending a request to the user to perform a single action on a communication device, receiving a verification that the user is using the communication device, and authenticating the user based on the user information and the verification that the user is using the communication device.

According to another embodiment, a computer-implemented method for authenticating a user includes receiving a user identification, confirming the user identification, sending a request to the user to perform a single action on a communication device, creating a session to receive the single action from the communication device, receiving an identifier from the communication device, using the identifier to verify that the user has the communication device, and authenticating the user based on the confirmed user information and the verification that the user has the communication device. The user identification can include a username and a password. The identifier can include a one time password. The identifier can include a signed message based on a certificate and a one time password. The communication device can be a handheld communication device. The identifier can include a phone number of the handheld communication device. The method can further include associating the authentication of the communication device with the session.

According to another embodiment, a method for authenticating a user includes receiving an identification of a single action communication device associated with a user identification, sending to the identified single action communication device a request that the user perform a single action on the communication device, receiving an identifier from the communication device, using the identifier to verify that the user has the communication device, and authenticating the user based on the user information and the verification that the user has the communication device. The user identification can include a username and a password. The identifier can be dynamically generated and is different depending on whether it is for transactions or authentication. The identifier can include a one time password. The identifier can include a signed message with a certificate. The communication device can be a handheld communication device. The identifier can include a phone number of the handheld communication device. The method can further include sending the first image to the user, and sending a request to the user to select the same first image on the communication device. The first image can correspond to a specific transaction. The method can further include requesting that the user select an image on the communication device identifying a specific transaction. The method can also further include associating the authentication of the communication device with the session.

According to another embodiment, a computer-implemented method for creating a secure communication channel between a handheld communication device and an entity, the handheld communication device having an identifier and security data associated therewith, the method including receiving the identifier from the entity, creating a session for a transaction between the entity and the handheld communication device, associating the session with the identifier, sending a request for the identifier and the security data to the handheld communication device, receiving the identifier and the security data from the handheld communication device, authenticating the handheld communication device based, in part, on the received identifier and the received security data, and notifying the entity of the authentication of the handheld communication device. The identifier can include a phone number of the handheld communication device. The method can further include associating the authentication of the handheld communication device with the session.

According to another embodiment, a computer-implemented method for authenticating a mobile communication device to an entity includes receiving, from the entity, an identifier associated with the mobile communication device, creating a session for communication between the mobile communication device and the entity, associating a first image with the session, transmitting the first image to the entity, receiving the identifier and a second image from the mobile communication device, validating the mobile communication device based, in part, on the identifier, the first image, and the second image, and communicating the validation of the mobile communication device to the entity. Validating the mobile communication device can include determining a match between the first image and the second image. The method can further include receiving, from the mobile communication device, security data associated with the mobile communication device.

According to another embodiment, a method for creating a communication channel between a handheld communication device and an entity includes receiving, from the handheld communication device, a signal associated with initiation of a transaction, receiving, from the entity, an identifier associated with the handheld communication device, providing information associated with the transaction to the handheld communication device, receiving input from the handheld communication device, and authenticating the handheld communication device based, in part, on the identifier and the input from the handheld communication device. The input can include the identifier and security data associated with the handheld communication device. Additionally, the input can further include confirmation of the information associated with the transaction.

According to another embodiment, a communication device includes a security application running on the device and a dedicated key for authenticating the user or the transaction. The dedicated key actuates the sending of an identifier that can be used to authenticate the user or the transaction. The communication device can have a security level that is configurable depending on the transaction.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claim. For example, “single action” events can include selecting a sequence of keys on the mobile device, selecting an image displayed on the mobile device via a touch screen, selecting several buttons at once on the mobile device, etc.

What is claimed is:

1. A computer-implemented method for authenticating a user, the method comprising:
receiving at a relying party from a user at least one first factor, wherein the first factor includes at least one from the group of a user identifier, a user password, a user One Time Password, a digital signature and user biometric data;
verifying at the relying party the at least one first factor sent from the user to the relying party;
sending a message from the relying party to the user requesting the user to contact a third party authentication service through a mobile device;
sending from the user mobile device to the third party authentication service at least one second factor, where the second factor sent to the third party authentication service includes at least one from the group of a user identifier, a user password, a user One Time Password, a digital signature and user biometric data;
verifying at the third party authentication service the at least one second factor sent to the authentication service;
sending a message from the third party authentication service to the relying party indicating whether the second factor sent to the third party authentication service has been successfully verified;
if the message received from the third party authentication service indicates that the second factor sent to the third party authentication service has been successfully verified and if the relying party successfully verifies the first factor sent to the relying party, then determining that the user is authentic.

2. The method of claim 1, further comprising:
sending from the relying party to the user a first image;
displaying the first image to the user;
showing on the mobile device a group of images that includes the first image;
receiving from the mobile device at the third party authentication service a signal corresponding to an image selected by the user;
if the image from the mobile device corresponds to the first image, then determining that the user is authentic.

3. A computer-implemented method for authenticating a user, the method comprising:
receiving at least one credential from a group of user credentials;
validating the user credential;
creating a session to receive a single action from a communication device;
associating a first image with the session;
sending a request to a user to select the same first image on the communication device;
receiving an identifier from the communication device, the identifier comprises a selected image selected by the user;
using the identifier to verify that the user has the communication device; and
authenticating the user based on the confirmed user information and the verification that the user has the communication device and has selected the image.

4. A computer-implemented method for authenticating a user, comprising:
receiving a user identification;
sending a request to the user to perform a single action on a communication device;
receiving a verification that the user is using the communication device; and
authenticating the user based on the user information and the verification that the user is using the communication device.

5. A computer-implemented method for authenticating a user, comprising:
receiving a user identification;
confirming the user identification;
sending a request to the user to perform a single action on a communication device;
creating a session to receive the single action from the communication device;
receiving an identifier from the communication device;
using the identifier to verify that the user has the communication device; and
authenticating the user based on the confirmed user information and the verification that the user has the communication device.

6. The method of claim 5 wherein the user identification comprises a username and a password.

7. The method of claim 5 wherein the identifier comprises a one time password.

8. The method of claim 5 wherein the identifier comprises a signed message based on a certificate and a one time password.

9. The method of claim 5 wherein the communication device is a handheld communication device.

10. The method of claim 9 wherein the identifier comprises a phone number of the handheld communication device.

11. The method of claim 5 further comprising associating the authentication of the communication device with the session.

12. A method for authenticating a user comprising:
receiving an identification of a one click communication device associated with a user identification;
sending to the identified single action communication device a request that the user perform a single action on the communication device;
receiving an identifier from the communication device;
using the identifier to verify that the user has the communication device; and
authenticating the user based on the user information and the verification that the user has the communication device.

13. The method of claim 12 wherein the user identification comprises a username and a password.

14. The method of claim 12 wherein the identifier is dynamically generated and is different depending on whether it is for transactions or authentication.

15. The method of claim 12 wherein the identifier comprises a one time password.

16. The method of claim 12 wherein the identifier comprises a signed message with a certificate.

17. The method of claim 12 wherein the communication device is a handheld communication device.

18. The method of claim 17 wherein the identifier comprises a phone number of the handheld communication device.

19. The method of claim 12 further comprising:
sending the first image to the user; and
sending a request to the user to select the same first image on the communication device.

20. The method of claim 19 wherein the first image corresponds to a specific transaction.

21. The method of claim 19 further comprising requesting that the user select an image on the communication device identifying a specific transaction.

22. The method of claim 12 further comprising associating the authentication of the communication device with the session.

23. A computer-implemented method for creating a secure communication channel between a handheld communication device and an entity, the handheld communication device having an identifier and security data associated therewith, the method comprising:
receiving the identifier from the entity;
creating a session for a transaction between the entity and the handheld communication device;
associating the session with the identifier;
sending a request for the identifier and the security data to the handheld communication device;
receiving the identifier and the security data from the handheld communication device;
authenticating the handheld communication device based, in part, on the received identifier and the received security data; and
notifying the entity of the authentication of the handheld communication device.

24. The method of claim 23 wherein the identifier comprises a phone number of the handheld communication device.

25. The method of claim 23 further comprising associating the authentication of the handheld communication device with the session.

26. A computer-implemented method for authenticating a mobile communication device to an entity, the method comprising:
receiving, from the entity, an identifier associated with the mobile communication device;
creating a session for communication between the mobile communication device and the entity;
associating a first image with the session;
transmitting the first image to the entity;
receiving the identifier and a second image from the mobile communication device;
validating the mobile communication device based, in part, on the identifier, the first image, and the second image; and
communicating the validation of the mobile communication device to the entity.

27. The method of claim 26 wherein validating the mobile communication device includes determining a match between the first image and the second image.

28. The method of claim 26 further comprising receiving, from the mobile communication device, security data associated with the mobile communication device.

29. A method for creating a communication channel between a handheld communication device and an entity, the method comprising:
receiving, from the handheld communication device, a signal associated with initiation of a transaction;
receiving, from the entity, an identifier associated with the handheld communication device;
providing information associated with the transaction to the handheld communication device;
receiving input from the handheld communication device; and
authenticating the handheld communication device based, in part, on the identifier and the input from the handheld communication device.

30. The method of claim 29 wherein the input includes the identifier and security data associated with the handheld communication device.

31. The method of claim 30 wherein the input further comprises confirmation of the information associated with the transaction.
